(19) United States
(12) Patent Application Publication
(10) Pub. No.: US 2022/0320756 A1
(43) Pub. Date: Oct. 6, 2022

(54) SINGLE PORT ORTHOGONALLY POLARIZED ANTENNA FOR HANDSETS, IOT TERMINALS, AND VEHICLES

(71) Applicants: Noha Hassan, Cairo (EG); Mohamed Sanad, Cairo (EG)

(72) Inventors: Noha Hassan, Cairo (EG); Mohamed Sanad, Cairo (EG)

(21) Appl. No.: 17/655,172

(22) Filed: Mar. 16, 2022

Related U.S. Application Data
(60) Provisional application No. 63/161,676, filed on Mar. 16, 2021.

(51) Int. Cl. H01Q 21/24; H01Q 21/00

(52) U.S. Cl. CPC H01Q 21/24; H01Q 21/0006; H01Q 1/3208

(57) ABSTRACT

A single port orthogonally terminal polarized antenna is disclosed herein. The antenna may be used in apparatuses including but not limited to handsets, Internet of Things (IoT) terminals, and vehicles. The antenna significantly reduces the need for spatial diversity multiple-in and multiple-out (MIMO) in terminals.

### CROSS-REFERENCE TO RELATED APPLICATIONS

This application claims the benefit of U.S. Provisional Patent Application Ser. No. 63/161,676, filed on Mar. 16, 2021, the entirety of which is hereby incorporated herein by reference.

### BACKGROUND

The present disclosure relates to the field of broadband resonant antennas.

### SUMMARY

A single port orthogonally polarized terminal antenna is disclosed herein. Use of the disclosed antenna significantly reduces the need for spatial diversity MIMO in terminals. The single port orthogonally polarized terminal antenna is equally sensitive in two perpendicular polarizations. Thus, a spatially separated dual MIMO antenna configuration is replaced by a single port orthogonally polarized terminal antenna.

The single port orthogonally polarized terminal antenna may reduce the need for spatial diversity MIMO in base station antennas. The single port orthogonally polarized terminal antenna may function as a feed for a dual parabolic cylindrical reflector base station antenna, by replacing the two spatially separated ±45° polarization feeds.

Additionally, the need for a spatial multiplexing MIMO may also be significantly reduced by using the multi-beam dual parabolic cylindrical reflector antenna. This is both because of its wide frequency bandwidth and its high capacity, with a large number of beams to achieve a simultaneous vertical and horizontal sectorization.

Further, the number of ports of the base station antenna is equal to the number of beams. This results from replacing the two spatially separated ±45° polarization feeds with an orthogonally polarized feed with a single port. This makes the antenna easier to handle. Additionally, the implementation of the single port orthogonally polarized terminal antenna improves in signal reception in vehicles.

The single port orthogonally polarized terminal antenna in conjunction with the single linearly polarized antenna result in improved reception with a 2×2 MIMO configuration. The 2×2 MIMO configuration results in a more efficient configuration (i.e., 3×3 MIMO and 4×4 MIMO) and better performance.

Each of the foregoing and various aspects, together with those set forth below and summarized above or otherwise disclosed herein, including the figures, may be combined without limitation to form claims for a device, apparatus, system, method of manufacture, and/or method of use.

### BRIEF DESCRIPTION OF THE DRAWINGS

FIG. 1 is a perspective view of the assembly for an embodiment of the disclosed antenna.

FIG. 2 is an exploded perspective view of the assembly for an embodiment of the disclosed antenna.

FIG. 3 is a front view of the assembly for an embodiment of the disclosed antenna.

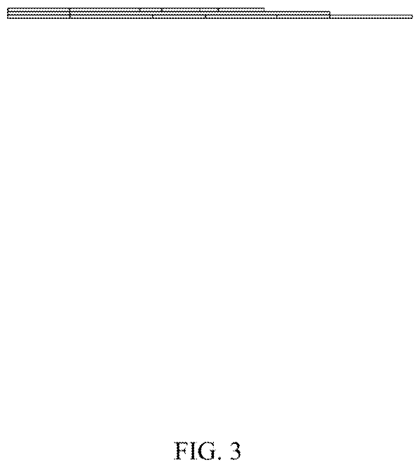

FIG. 4 is a right view of the assembly for an embodiment of the disclosed antenna.

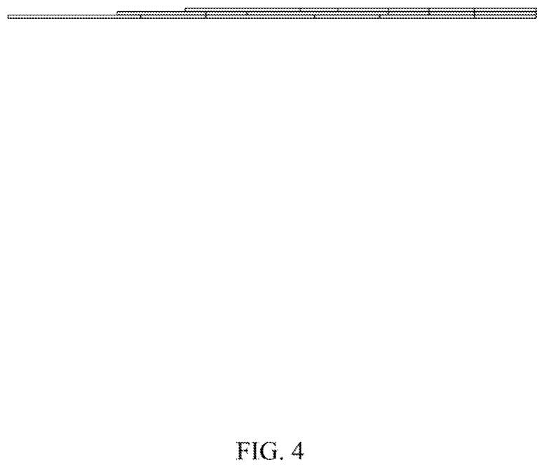

FIG. 5 is a rear view of the assembly for an embodiment of the disclosed antenna.

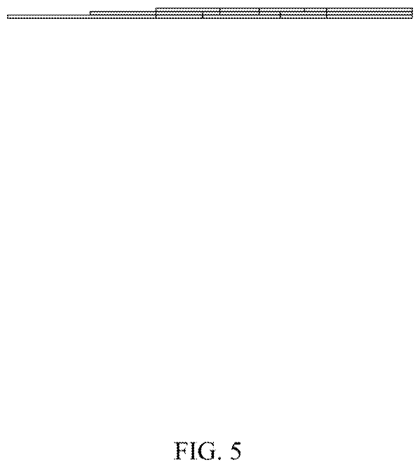

FIG. 6 is a left view of the assembly for an embodiment of the disclosed antenna.

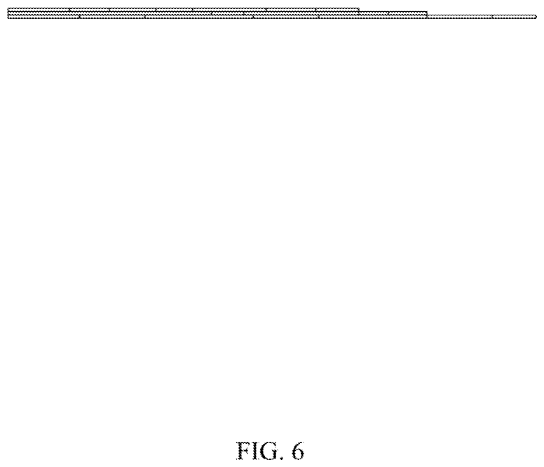

FIG. 7 is a top view of the assembly for an embodiment of the disclosed antenna.

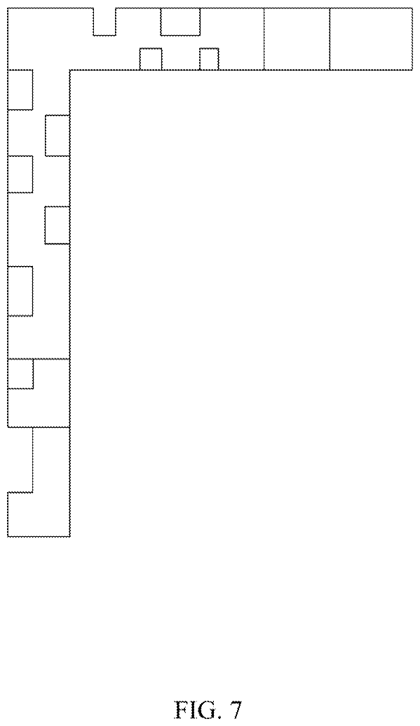

FIG. 8 is a bottom view of the assembly for an embodiment of the disclosed antenna.

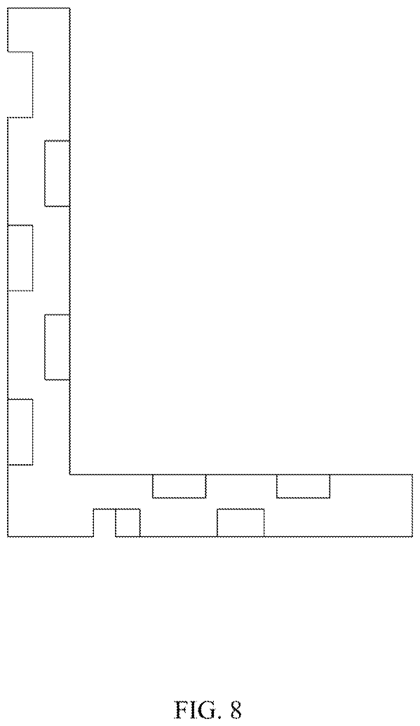

### DETAILED DESCRIPTION

A single port orthogonally polarized terminal antenna is disclosed herein. Use of the disclosed antenna significantly reduces the need for spatial diversity MIMO in terminals. The single port orthogonally polarized terminal antenna is equally sensitive in two perpendicular polarizations. Thus, a spatially separated dual MIMO antenna configuration is replaced by a single port orthogonally polarized terminal antenna.

The single port orthogonally polarized terminal antenna may reduce the need for spatial diversity MIMO in base station antennas. The single port orthogonally polarized terminal antenna may function as a feed for a dual parabolic cylindrical reflector base station antenna, by replacing the two spatially separated ±45° polarization feeds.

Additionally, the need for a spatial multiplexing MIMO may also be significantly reduced by using the multi-beam dual parabolic cylindrical reflector antenna. This is both because of its wide frequency bandwidth and its high capacity, with a large number of beams to achieve a simultaneous vertical and horizontal sectorization.

Further, the number of ports of the base station antenna is equal to the number of beams. This results from replacing the two spatially separated ±45′ polarization feeds with an orthogonally polarized feed with a single port. This makes the antenna easier to handle. Additionally, the implementation of the single port orthogonally polarized terminal antenna improves in signal reception in vehicles.

The single port orthogonally polarized terminal antenna in conjunction with the single linearly polarized antenna result in improved reception with a 2×2 MIMO configuration. The 2×2 MIMO configuration results in a more efficient configuration (i.e., 3×3 MIMO and 4×4 MIMO) and better performance.

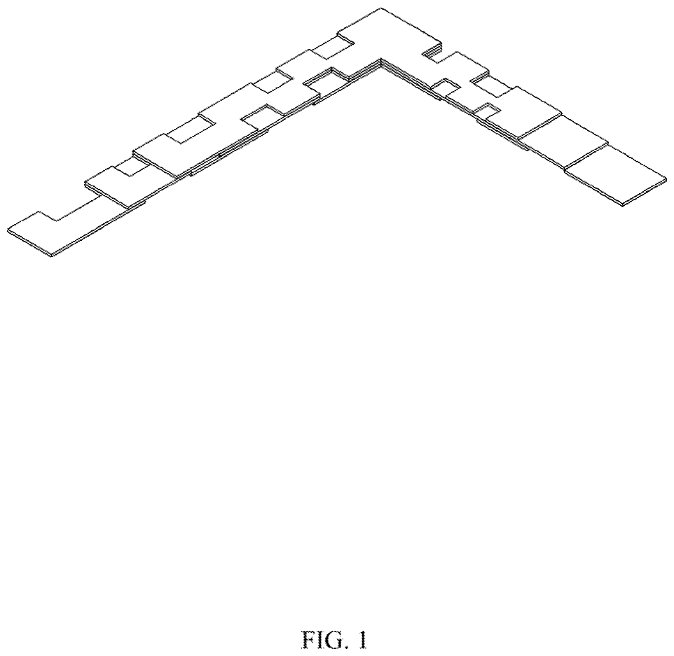

In some embodiments, the antenna comprises a first arm, a second arm, and a third arm. The first arm, second arm, and third arm may preferably be made from a conductive material, such as metal. The first arm, second arm, and third arm comprise an orthogonal geometrical profile as shown in FIG. 1. The first arm, second arm, and third arm are adjacent, parallel, and colinear when assembled.

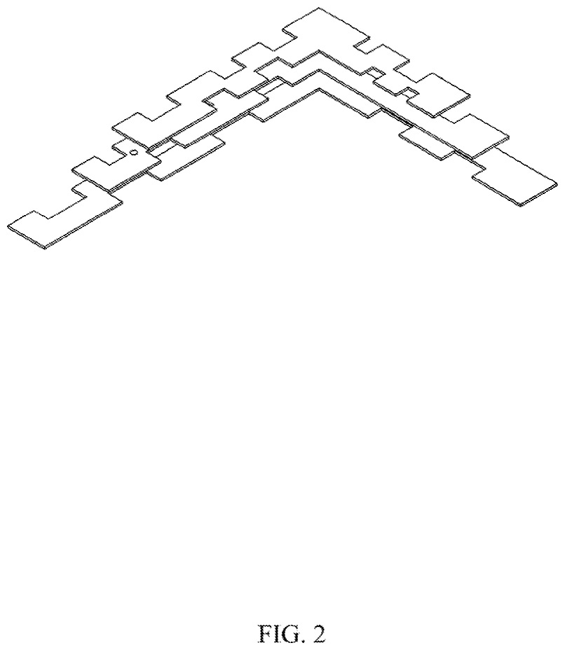

In addition, the antenna includes a feed point, as shown in FIG. 2. The location of the feed point may be adjusted as necessary in order to improve return loss. The lengths of the first arm, second arm, and third arm are dimensionally related. Preferably, the length of the first arm is greater than the length of the second arm, and the length of the second arm is greater than the length of the third arm.

In some preferred embodiments, the first arm is the base layer, the second arm is the middle layer, and the third arm is the top layer, as shown in FIG. 2. In addition, the first arm, second arm, and third arm have a plurality of slots. The plurality of slots may have any geometrical profile which fulfills design, manufacturing, and/or user requirements.

The dimensions of the first arm, second arm, and third arm and the plurality of slots provide the necessary configuration such that the disclosed antenna does not require any matching/tuning circuits or any additional extended ground planes. Thus, the dimensions of the antenna are directly correlated with its performance.

In some embodiments, the length of the first arm determines the operating frequency of the antenna. Additional parameters such as bandwidth, peak gain, and efficiency are mainly determined by the widths of the second arm and the third arm. In addition, the arrangement of the plurality of slots may be optimized so as to enhance performance, particularly with respect to bandwidth.

In some preferred embodiments, the feeding method for the antenna is a direct feed into the first arm and second arm, while the third arm is fed via coupling. The direct feed into the first arm and second arm may be via a coaxial cable.

The disclosed antenna preferably covers the entire Long Term Evolution (LTE) band (0.7-5.8 GHz), the 5G sub-6 GHz band (3.3-7 GHz), and/or the mm-wave band (24-34 GHz) for cellular handsets, smart phones, tablets, vehicles, and IoT terminals without using any matching or tuning circuits.

The single port orthogonally polarized terminal antenna significantly reduces the need for spatial diversity MIMO in terminals. The single port orthogonally polarized terminal antenna also reduces the need for spatial diversity MIMO in base station antennas. Further applications include using the antenna as a feed for a dual parabolic cylindrical reflector base station antenna to replace its two spatially separated ±45° polarization feeds.

Additional applications include vehicular applications, where the vehicle in question frequently changes direction. The repeated change of direction affects the polarization of vehicular antennas.

Typically, vehicular antennas are required to communicate with linearly polarized systems such as cellular base stations and circularly polarized systems such as GPS and satellite phones. Additionally, vehicular antennas may be required to communicate with other systems without a free line of sight, which results in multi-path reflections and multiple rotation of polarization.

To overcome the aforementioned challenges, the single port orthogonally polarized terminal antenna is implemented with a single linearly polarized antenna in a 2×2 MIMO configuration.

The single port orthogonally polarized terminal antenna and the single linearly polarized antenna are sensitive to three perpendicular polarizations and circular polarizations. Thus, this vehicular configuration is more efficient in GPS and satellite phones. Use of the disclosed antenna results in improved reception in all directions and polarizations. The isolation between the two antennas of each group is still better than 35 dB over most of the 5G Sub-6 GHz band (3.3-7 GHz).

Additional applications of the single port orthogonally polarized terminal antenna include multi-beam base station antennas. Use of the disclosed antenna results in a significant reduction in the need for MIMO. For example, in recent years a foldable/deployable 5G multi-beam base station antenna was developed by Hassan, et al. The foldable/deployable 5G multi-beam base station antenna could cover the entire sub-6 GHz band (3.3-7.0 GHz) or the mm-wave band (24-34 GHz). It consists of two parabolic cylindrical reflectors and a set of small broadband resonant feeds, where four of these units were used to cover the entire azimuth.

The proposed base station antenna generates an arbitrary number of beams with arbitrary vertical and horizontal beamwidths, arbitrary beam overlapping, and arbitrary electric beam-tilt for each beam. Further, the beams may be shaped in the elevation plane to eliminate any possible ducting and/or interference with surrounding base station antennas. Multi-beam technology may easily be applied to the dual parabolic cylindrical reflector antenna by adding multi-feeds. Shifting the location of a feed away from the focus of the sub-reflector results in tilting the beam generated by this feed.

Thus, each beam may readily be tilted vertically and/or horizontally by remotely shifting its feed. Further, an array of feeds with different horizontal and vertical shifts may be used in conjunction to generate simultaneous horizontal and vertical sectorization. Thus, the developed multi-beam base station antenna can generate a large number of beams (up to 60 beams with 120 ports for ±45° polarizations). The ±45° polarizations are used in spatial diversity MIMO and/or in spatial multiplexing MIMO. The need for a spatial multiplexing MIMO may be significantly reduced because of the high capacity of the multibeam antenna, with its large number of beams and wide frequency bandwidth.

To reduce the need for spatial diversity MIMO, the single port orthogonally polarized feed antenna is implemented to cover the 5G Sub-6 GHz spectrum (3.3-7.0 GHz) or the mm-wave spectrum (24-34 GHz). Since the antenna is equally sensitive to two perpendicular polarizations (±45°), the two spatially separated ±45° polarization feeds are readily replaced by an orthogonally polarized feed with a single port. Thus, the number of ports is equal to the number of beams.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Further, any range of numbers recited above describing or claiming various aspects of the invention, such as ranges that represent a particular set of properties, units of measure, conditions, physical states, or percentages, is intended to literally incorporate any number falling within such range, including any subset of numbers or ranges subsumed within any range so recited. The terms “about” and “approximately” when used as modifiers are intended to convey that the numbers and ranges disclosed herein may be flexible as understood by ordinarily skilled artisans and that practice of the disclosed invention by ordinarily skilled artisans using properties that are outside of a literal range will achieve the desired result.

Each of the foregoing and various aspects, together with those summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. An antenna system comprising:
a base layer consisting of a first antenna component having at least a first set of two radiation elements joined together in an orthogonal arrangement;
a middle layer consisting of a second antenna component having at least a second set of two radiation elements joined together in an orthogonal arrangement;
a top layer consisting of a third antenna component having at least a third set of two radiation elements joined together in an orthogonal arrangement; and
a feed port;
wherein the length of the first set of two radiation elements is longer than the second set of two radiation elements and the length of the second set of two radiation elements is longer than the third set of two radiation elements.
